(19) United States
(12) Patent Application Publication
(10) Pub. No.: US 2026/0268680 A1
(43) Pub. Date: Sep. 10, 2026

(54) MULTI-TASK THREE-DIMENSIONAL PERCEPTION THROUGH GENERALIZED CROSS-MODAL DISTILLATION

(71) Applicant: QUALCOMM Incorporated, San Diego, CA (US)

(72) Inventors: Maciej WOZNIAK, Stockholm (SE); Hariprasath GOVINDARAJAN, Linköping (SE); Marvin Richard KLINGNER, Braunschweig (DE); Camille MAURICE, München (DE); Kiran BANGALORE RAVI, Paris (FR); Senthil Kumar YOGAMANI, San Diego, CA (US)

(21) Appl. No.: 19/309,452

(22) Filed: Aug. 25, 2025

Related U.S. Application Data
(60) Provisional application No. 63/768,087, filed on Mar. 6, 2025.

(51) Int. Cl. G06V 20/56; G01S 17/89; G06N 20/00; G06T 17/00; G06V 10/25; G06V 10/44

(52) U.S. Cl. CPC G06V 20/56; G01S 17/89; G06N 20/00; G06T 17/00; G06V 10/25; G06V 10/44

(57) ABSTRACT

Systems and techniques are described for providing improved distillation techniques for machine learning models. For example, a computing device can obtain data comprising three-dimensional sensor data of a scene. The computing device can process the three-dimensional sensor data using a trained machine learning model to generate first features. The computing device can process the first features using a projection model to generate projected features. The computing device can process the first features using at least one three-dimensional component to generate at least one three-dimensional output. The computing device can process the projected features using at least one two-dimensional component to generate at least one two-dimensional output.

### CROSS REFERENCE TO RELATED APPLICATIONS

This Application claims priority to U.S. Provisional Application No. 63/768,087, filed Mar. 6, 2025, the content of which is incorporated herein by reference in its entirety for all purposes.

### FIELD

The present disclosure relates to machine learning. For example, aspects of the present disclosure relate to systems and techniques for providing improved distillation of machine learning models.

### BACKGROUND

Many devices and systems can obtain data (e.g., image frames or video), such as from their environment (e.g., including a scene). In some cases, the data can be processed for performing one or more functions, can be output for display, can be output for processing and/or consumption by other devices, among other uses.

Machine learning systems or models (e.g., deep neural network systems or models) can be used to perform a variety of tasks. For instance, an artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. In some examples, convolutional neural networks can extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for training a machine learning model is provided. The apparatus includes one or more memories and at least one processor coupled to the one or more memories and configured to: obtain training data including three-dimensional sensor data of a scene and a two-dimensional camera image of the scene; process the three-dimensional sensor data using a first machine learning model to generate first features; process the two-dimensional camera image using a second machine learning model to generate second features; process the first features using a projection model to generate projected features; and adjust parameters of the first machine learning model based on a cross-model distillation loss, wherein the cross-model distillation loss is based on comparison of the second features and the projected features.

In some aspects, a method for training a machine learning model. The method includes: obtaining training data including three-dimensional sensor data of a scene and a two-dimensional camera image of the scene; processing the three-dimensional sensor data using a first machine learning model to generate first features; processing the two-dimensional camera image using a second machine learning model to generate second features; processing the first features using a projection model to generate projected features; and adjusting parameters of the first machine learning model based on a cross-model distillation loss, wherein the cross-model distillation loss is based on comparison of the second features and the projected features.

In some aspects, a non-transitory computer-readable medium is provided that has stored thereon instructions that, when executed by one or more processors, cause the one or more processors to: obtain training data including three-dimensional sensor data of a scene and a two-dimensional camera image of the scene; process the three-dimensional sensor data using a first machine learning model to generate first features; process the two-dimensional camera image using a second machine learning model to generate second features; process the first features using a projection model to generate projected features; and adjust parameters of the first machine learning model based on a cross-model distillation loss, wherein the cross-model distillation loss is based on comparison of the second features and the projected features.

In some aspects, an apparatus for training a machine learning model is provided. The apparatus includes: means for obtaining training data including three-dimensional sensor data of a scene and a two-dimensional camera image of the scene; means for processing the three-dimensional sensor data using a first machine learning model to generate first features; means for processing the two-dimensional camera image using a second machine learning model to generate second features; means for processing the first features using a projection model to generate projected features; and means for adjusting parameters of the first machine learning model based on a cross-model distillation loss, wherein the cross-model distillation loss is based on comparison of the second features and the projected features.

In some aspects, an apparatus of using a machine learning model (e.g., at inference) is provided. The apparatus includes one or more memories; and at least one processor coupled to the one or more memories and configured to: obtain data including three-dimensional sensor data of a scene; process the three-dimensional sensor data using a trained machine learning model to generate first features; process the first features using a projection model to generate projected features; process the first features using at least one three-dimensional component to generate at least one three-dimensional output; and process the projected features using at least one two-dimensional component to generate at least one two-dimensional output.

In some aspects, a method of using a machine learning model (e.g., at inference) is provided. The method includes: obtaining data including three-dimensional sensor data of a scene; processing the three-dimensional sensor data using a trained machine learning model to generate first features; processing the first features using a projection model to generate projected features; processing the first features using at least one three-dimensional component to generate at least one three-dimensional output; and processing the projected features using at least one two-dimensional component to generate at least one two-dimensional output.

In some aspects, a non-transitory computer-readable medium is provided that has stored thereon instructions that, when executed by one or more processors, cause the one or more processors to: obtain data including three-dimensional sensor data of a scene; process the three-dimensional sensor data using a trained machine learning model to generate first features; process the first features using a projection model to generate projected features; process the first features using at least one three-dimensional component to generate at least one three-dimensional output; and process the projected features using at least one two-dimensional component to generate at least one two-dimensional output.

In some aspects, an apparatus for using a machine learning model (e.g., at inference) is provided. The apparatus includes: means for obtaining data including three-dimensional sensor data of a scene; means for processing the three-dimensional sensor data using a trained machine learning model to generate first features; means for processing the first features using a projection model to generate projected features; means for processing the first features using at least one three-dimensional component to generate at least one three-dimensional output; and means for processing the projected features using at least one two-dimensional component to generate at least one two-dimensional output.

In some aspects, one or more of the apparatuses described herein is, can be part of, or can include a vehicle (or a computing device, system, or component of a vehicle), an extended reality device (e.g., a virtual reality (VR) device, an augmented reality (AR) device, or a mixed reality (MR) device), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIGS. 1A and 1B are block diagrams illustrating a vehicle suitable for implementing various techniques described herein, in accordance with some aspects of the disclosure.

FIG. 1C is a block diagram illustrating components of a vehicle suitable for implementing various techniques described herein, in accordance with some aspects of the disclosure.

FIG. 1D illustrates an example implementation of a system-on-a-chip (SOC), in accordance with some aspects of the disclosure.

FIG. 2 is a block diagram illustrating an example architecture of an image capture and processing system, in accordance with some aspects of the disclosure.

FIG. 3 is a block diagram illustrating an example of training for an improved machine learning system, in accordance with some aspects of the disclosure.

FIG. 4 is a block diagram illustrating an example of inference for an improved machine learning system, in accordance with some aspects of the disclosure.

FIG. 5 is a block diagram illustrating an example of a deep learning network, in accordance with some aspects of the disclosure.

FIG. 6 is a block diagram illustrating an example of a convolutional neural network, in accordance with some aspects of the disclosure.

FIG. 7 is a flow diagram illustrating an example of a process for training a machine learning model, in accordance with some aspects of the disclosure.

FIG. 8 is a flow diagram illustrating an example of a process for using a machine learning model, in accordance with some aspects of the disclosure.

FIG. 9 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted above, machine learning systems or models (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

In one or more aspects of the present disclosure, systems, apparatuses, methods (also referred to as processes), and computer-readable media (collectively referred to herein as “systems and techniques”) are described herein for improved machine model distillation that results in improved machine learning models usable for three-dimensional (3D) applications. In some examples, the systems and techniques can provide multi-task three-dimensional perception through generalized cross-modal distillation.

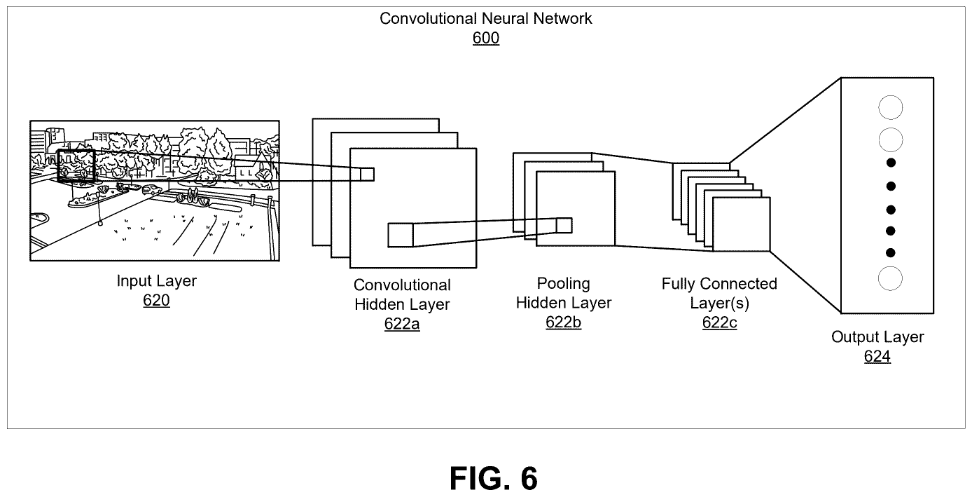

For instance, the systems and techniques can employ a two-dimensional (2D) feature extraction model (e.g., a feature extraction neural network) that can process camera images to generate 2D features representing the camera images. The 2D feature extraction model can be referred to as a 2D teacher model. The systems and techniques can also employ a 3D feature extraction model (e.g., a feature extraction neural network) that can process 3D point cloud data (e.g., from one or more sensors, such as LIDAR sensors or other types of sensors) to generate 3D features representing the point cloud data. The 3D feature extraction model can be referred to as a 3D student model. In some cases, the 2D feature extraction model and/or the 3D feature extraction model can include one or more convolutional neural networks (CNN). An example of a CNN is discussed further with respect to FIG. 6.

The systems and techniques can use a projection head (e.g., a multilayer perceptron (MLP) projection head) to project the 3D features to 2D features (which can be referred to as projected features) so that the features representing the 3D point cloud data and the features representing the images have the same dimension. The projection head can include multiple projection layers that maintain the feature abstraction and retain complex information learned by the 3D feature extraction model. In some aspects, the systems and techniques can determine 3D points from the input data (e.g., LIDAR points) that correspond to parts of camera images (referred to as corresponding points) and/or can determine 3D points from the 3D features parts that correspond to parts of the 2D features generated from the camera images by the camera-based foundation model referred to as corresponding features). The corresponding points/features can be determined based on a calibration and known transforms (e.g., using extrinsic and/or intrinsic parameters of the camera and/or sensors used to capture the images and 3D point cloud data). The corresponding points or features can be input to the projection head, which can allow the projection head to project the 3D features in a way that can associate the 3D features with the corresponding 2D features.

The systems and techniques can then determine a cross-model distillation loss by comparing the 2D features representing the images and the projected features. In some aspects, the systems and techniques can use self-supervised occupancy loss to pre-train 3D models in addition to the above-noted cross-modal distillation loss. The 2D cross-modal distillation loss can ensure knowledge transfer of rich semantics from foundational models, while a 3D auxiliary loss (e.g., the occupancy loss) can ensure 3D structural consistency.

Parameters of the 3D student model and the projection head can then be tuned based on the cross-model distillation loss (e.g., by performing backpropagation based on the loss). Once trained, the 3D student model can be used during inference to process input point cloud data and generate 3D features, which can be used for one or more downstream tasks. For instance, due to generalized and structurally aware 3D features, the model can be applied to various 3D tasks during inference with different output structures (e.g., bounding boxes vs. segmentation). In some aspects, the systems and techniques can generate 2D and 3D outputs. For instance, based on the trained projection head (e.g., the MLP projection head), the same 3D backbone can be used to support 3D as well as 2D tasks. Multi-task inference can thus be performed based on generalized 3D features generated by the 3D student model, such as 3D semantic segmentation, 3D object detection, 2D object detection, 2D semantic segmentation, etc. To perform the 2D tasks (e.g., 2D object detection, 2D semantic segmentation, etc.), the 3D features can be processed by the trained projection head (e.g., an MLP projection head) to project the 3D features to 2D features, which can be processed by respective decoders to perform the 2D tasks.

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an advanced driver-assistance system (ADAS) or other system or component) of the vehicle.

Various aspects of the present disclosure will be described with respect to the figures. Further aspects and examples related to the present disclosure are included in Appendix A attached hereto, which is hereby incorporated by reference in its entirety and for all purposes.

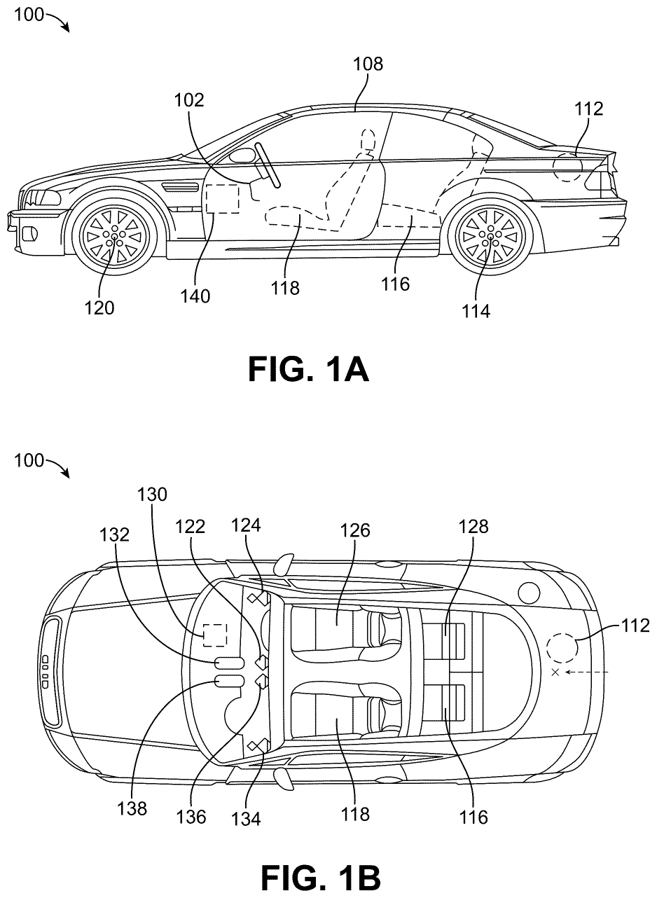

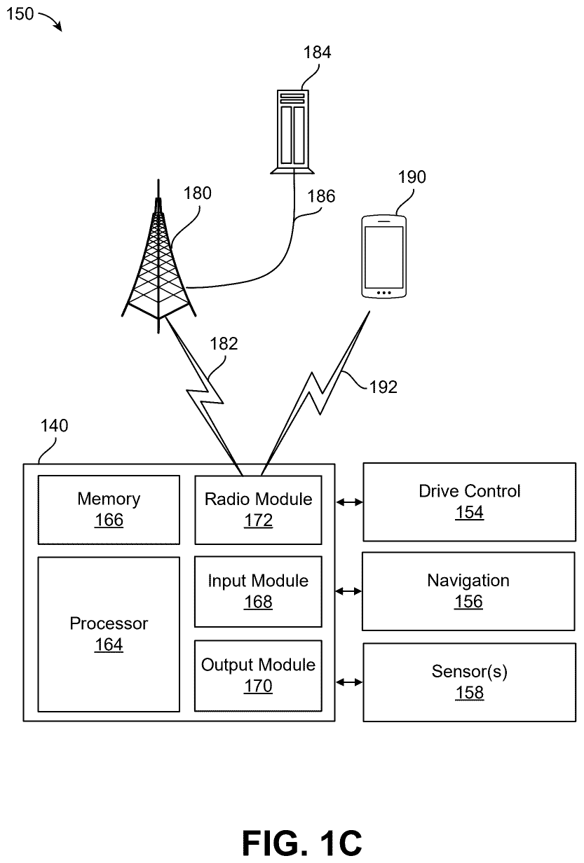

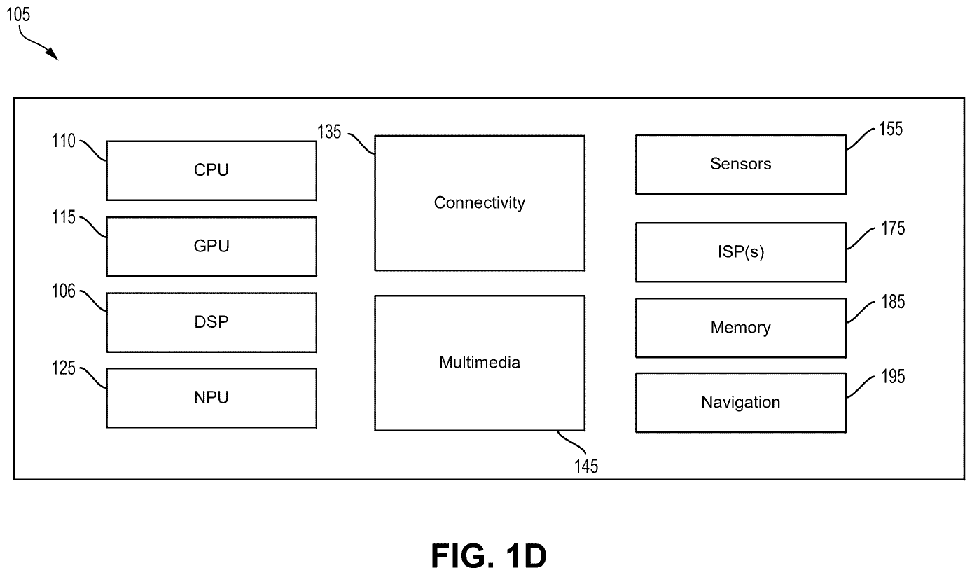

FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, radar 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various embodiments using information received from various sensors, particularly the cameras 122, 136, radar 132, and LIDAR 138. In some embodiments, the control unit 140 may supplement the processing of camera images using distance and relative position information (e.g., relative bearing angle) that may be obtained from radar 132 and/or LIDAR 138 sensors. The control unit 140 may further be configured to control steering, breaking and speed of the vehicle 100 when operating in an autonomous or semi-autonomous mode using information regarding other vehicles determined using various embodiments.

FIG. 1C is a component block diagram illustrating a system 150 of components and support systems suitable for implementing various embodiments. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various embodiments. The processor 164 may be coupled to the memory 166. The control unit 140 may include the input module 168, the output module 170, and the radio module 172.

The radio module 172 may be configured for wireless communication. The radio module 172 may exchange signals 182, 192 (e.g., command signals for controlling maneuvering, signals from navigation facilities, etc.) with a network node 180, and may provide the signals 182 to the processor 164 and/or the navigation components 156. In some embodiments, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described, and may the configured to provide a variety of data to the processor 164.

While the control unit 140 is described as including separate components, in some embodiments some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various embodiments when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

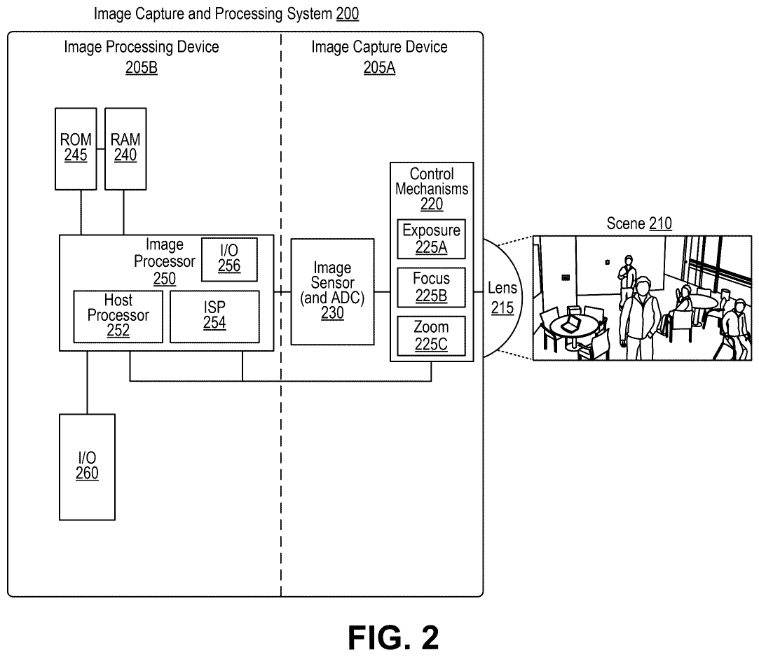

FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. A lens 215 of the system 200 faces a scene 210 and receives light from the scene 210. The lens 215 bends the light toward the image sensor 230. The light received by the lens 215 passes through an aperture controlled by one or more control mechanisms 220 and is received by an image sensor 230.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo, thereby adjusting focus. In some cases, additional lenses may be included in the system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), or some combination thereof. The focus setting may be determined using the control mechanism 220, the image sensor 230, and/or the image processor 250. The focus setting may be referred to as an image capture setting and/or an image processing setting.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 225C moves one or more of the lenses in the afocal zoom system, such as the negative lens and one or both of the positive lenses.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 230 may alternately or additionally include opaque and/or reflective masks that block light from reaching certain photodiodes, or portions of certain photodiodes, at certain times and/or from certain angles, which may be used for phase detection autofocus (PDAF). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 250 may include one or more processors, such as one or more image signal processors (TSPs) (including ISP 254), one or more host processors (including host processor 252), and/or one or more of any other type of processor 910 discussed with respect to the computing system 900. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™ Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 925, read-only memory (ROM) 920, a cache 912, a memory unit (e.g., system memory 915), another storage device 930, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output devices 935, any other input devices 945, or some combination thereof. In some cases, a caption may be input into the image processing device 205B through a physical keyboard or keypad of the I/O devices 260, or through a virtual keyboard or keypad of a touchscreen of the I/O devices 260. The I/O 260 may include one or more ports, jacks, or other connectors that enable a wired connection between the system 200 and one or more peripheral devices, over which the system 200 may receive data from the one or more peripheral device and/or transmit data to the one or more peripheral devices. The I/O 260 may include one or more wireless transceivers that enable a wireless connection between the system 200 and one or more peripheral devices, over which the system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

The host processor 252 can configure the image sensor 230 with new parameter settings (e.g., via an external control interface such as I2C, I3C, SPI, GPIO, and/or other interface). In one illustrative example, the host processor 252 can update exposure settings used by the image sensor 230 based on internal processing results of an exposure control algorithm from past image frames. The host processor 252 can also dynamically configure the parameter settings of the internal pipelines or modules of the ISP 254 to match the settings of one or more input image frames from the image sensor 230 so that the image data is correctly processed by the ISP 254. Processing (or pipeline) blocks or modules of the ISP 254 can include modules for lens (or sensor) noise correction, de-mosaicing, color conversion, correction or enhancement/suppression of image attributes, denoising filters, sharpening filters, among others. Each module of the ISP 254 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

As noted previously, systems and techniques are described herein that provide improved knowledge distillation techniques for machine learning models such as foundational models. A foundational model is a model that is trained on large and diverse datasets such that it may be applied across a wide range of use cases, such as universal feature extraction, segmentation, detection, vision tasks, and so forth.

For example, the self distillation, No labels (DINO) model and others may produce universal features suitable for image-level visual tasks (image classification, instance retrieval, video understanding) as well as pixel-level visual tasks (depth estimation, semantic segmentation). Vision foundational models such as DINO use self-supervised pre-training on images for training powerful vision foundational models. Such models produce universal features for image-level visual tasks (image classification, instance retrieval, video understanding) and pixel-level visual tasks (depth estimation, semantic segmentation, feature matching).

Improved models as discussed herein may be used in image-based perception tasks (e.g., used in automated driving tasks, extended reality (XR) tasks, etc.), such as 2D object detection, 2D object segmentation, 3D object detection, 3D segmentation, among others. For instance, multi-modal foundational models may be applied in multi-task perception, which can provide label-free pre-training of generalized backbones, a generalized backbone with task-specific heads, zero-shot performance on many tasks, etc. The foundational models may also be adapted to new datasets and/or data sensors.

Two-dimensional (2D) foundational models can support a variety of tasks due to general features. General features are features that are generally universal across tasks and therefore training for individual 2D tasks may not be necessary. Such foundational models are not easily repurposed for 3D applications. For instance, existing foundational models are trained for image-based applications, which are 2D, and thus do not apply to 3D-based solutions such as 3D object detection or 3D semantic segmentation based on 3D point cloud inputs (e.g., LIDAR data).

Some approaches to repurposing foundational models exist. For example, a foundational model may be used to distill the model knowledge to image and LIDAR based methods. However, approaches to using these models for 3D applications suffer from deficiencies. For instance, using existing approaches to 2D to 3D distillation may be focused only on a single task. Additionally, re-training or distilling existing models may be impractical, as more resources are needed to adapt the trained model to new tasks, and to a new sensor set, either re-training or employing distillation methods. Further, complex algorithms may rely on complex explicit semantic cues or hard-to-optimize contrastive learning objectives. Such a phenomenon affects all 3D-data based perception systems. For instance, fast and efficient inference of the same LIDAR model on various tasks and LIDAR sensors may be difficult.

The systems and techniques described herein provide improve training and inference of models to enable model distillation that supports multiple tasks at inference. The systems and techniques enable 3D networks that are applicable to various types of sensors (e.g., 3D sensors, including LIDAR sensors and/or other types of sensors providing 3D data such as point cloud data) and various 3D tasks such as 3D object detection and semantic segmentation with minimal adaptations per task.

According to various aspects, as described herein, the systems and techniques provide a self-supervised learning framework that distills knowledge from camera based foundational models to machine learning models or systems that process 3D point cloud data (e.g., neural networks, such as LIDAR networks) to generate 3D features representing the 3D point cloud data. For instance, a 2D feature extraction model configured to generate features from camera images can be used as a teacher network, which can be used to force a 3D feature extraction model (used as a student network) to generate features to be similar to the 2D features extracted from the camera images.

In some aspects, the systems and techniques can determine 3D points from the input data (e.g., LIDAR points) or from the 3D features that correspond to parts of camera images or parts from 2D features generated from the camera images by the camera-based foundation models, which are referred to as corresponding points or corresponding features. The corresponding points/features can be determined based on a calibration and known transforms (e.g., using extrinsic and/or intrinsic parameters of the camera and/or sensors used to capture the images and 3D point cloud data). The corresponding points/features can be input to a projection head (e.g., an MLP projection head). The projection head can project the 3D features to 2D features. Further, in cross-modal distillation tasks, the systems and techniques can compare the corresponding regions and, as noted above, use the 2D feature extraction model as a teacher, thus enforcing the features generated by the 3D feature extraction model to be similar to the features extracted from 2D feature extraction model.

Certain aspects further perform an auxiliary 3D spatial task. For example, an occupancy approach can be used, but other options such as scene flow or temporal consistency can also be used. This task ensures that the 3D feature extraction model not only learns 2D semantic information from the camera but also retains 3D environment understanding of the world.

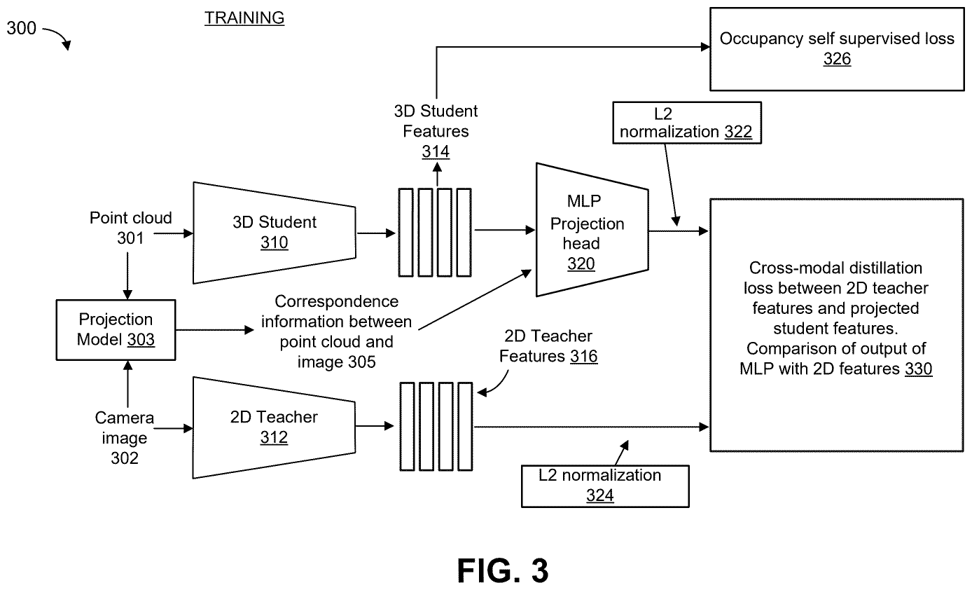

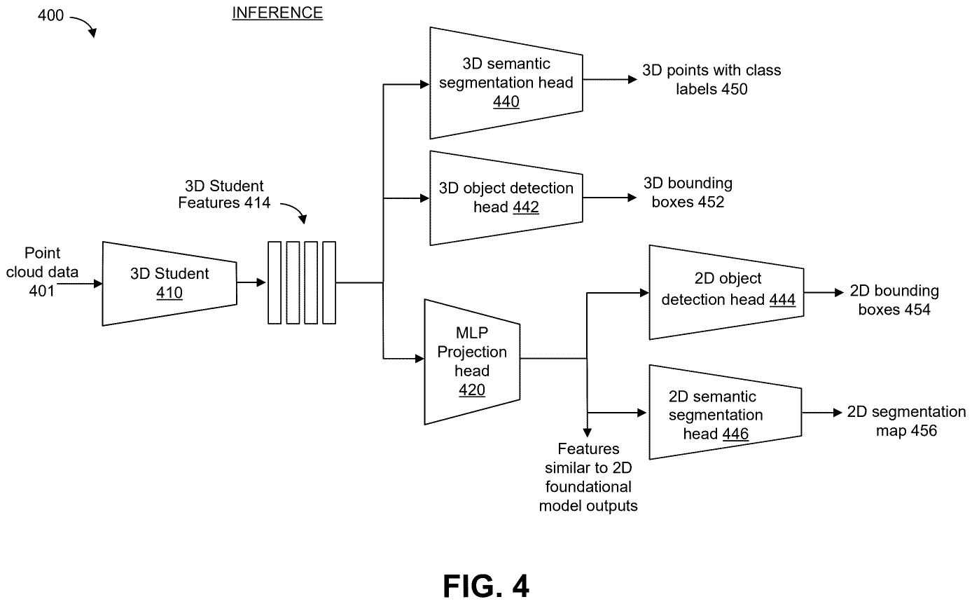

The systems and techniques described herein can improve model performance across different domains, not only the domain a model was trained on. The systems and techniques can also achieve state-of-the-art performance on linear probing and partially labelled data. Further, the systems and techniques can achieve state-of-the-art performance, beating expectations, on a corrupted LIDAR benchmark. FIG. 3 depicts an example of improved training, and FIG. 4 depicts an example of improved inference.

FIG. 3 is a block diagram illustrating an example of training for an improved machine learning system 300, in accordance with some aspects of the disclosure. System 300 involves distillation between machine learning models. In the example depicted, system 300 obtains point cloud data 301 (e.g., LIDAR point cloud data or other 3D point cloud data) and camera image 302 and performs cross-modal distillation from a 2D “teacher” model 312 to a 3D “student” model 310. In an example, camera image 302 may be obtained via image capture and processing system 200.

System 300 leverages the knowledge of the 2D teacher model 312 to create an improved 3D student model 310, including an ability to generate universal features so that the trained model is not tied to any particular task. As explained below, the input during training are pairs of camera images and point clouds (e.g., LIDAR point clouds).

The system 300 can receive point cloud data 301 (e.g., a LIDAR sensor or other type of sensor, such as LIDAR 138 of FIG. 1A) and camera image 302 (e.g., from a camera system, such as the image capture and processing system 200 of FIG. 2). Point cloud data 301 is provided to 3D student model 310. The 3D student model 310 can process the point cloud data 301 to generate 3D student features 314. The 3D features 314 are provided to MLP projection head 320, which projects the features 314 into 2D in learned fashion (e.g., based on training of the MLP projection head 320). Camera image 302 is provided to 2D teacher model 312. The 2D teacher model 312 can process the camera image 302 to generate 2D teacher features 316. In some examples, 2D teacher model 312 is a DINO model, but can include other types of models.

System 300 can also include projection model 303. Projection model 303 generates correspondence information 305 between point cloud data 301 and camera image 302. In an aspect, sensor calibration information may be used to generate the correspondence information 305. For instance, a point cloud can be projected onto the image plane using sensor calibration parameters, such as based on a pinhole projection model.

In some cases, correspondence information 305 may be derived directly from comparing point cloud data 301 with camera image 302. In this manner, a feature in the cloud data 301 may be associated with a feature in the image. In some cases, the correspondence information 305 may be identified at a feature level. For instance, correspondence information 305 may be derived by comparing 3D features 314 and 2D features 316.

Correspondence information 305 is provided, along with 3D student features 314 to MLP projection head 320. The correspondence information 305 guides the projection of the 3D features 314 by MLP projection head 320. For instance, because the 2D and 3D features differ in shape, for example, as a 3D point cloud is processed differently than a camera image, the MLP projection head 320 can projects 3D features into the same space as the 2D features 316. The resulting projection may be learnable, such that it may improve over iterations of training.

System 300 compares the 2D features to 3D features with one or more loss functions. Various loss functions can be used. For instance, as shown in FIG. 3, the 3D features 314 are compared to the 2D features 316 using a cross-modal distillation loss 330, which can encourage the features output by the 3D student model 310 to be similar to the features output by the 2D teacher model 312. In some cases, the 3D student features 314 can also be processed using a self-supervised occupancy loss 326, which can encourage 3D structural consistency and ensures that the 3D student model 310 not only learns 2D semantic information from the camera images but also retain 3D environment understanding of the world. Backpropagation can be used to train the 3D student model 310 and the MLP projection head 320. In some cases, L2 normalization can be used to ensure scale consistency. For instance, L2 normalization can be applied at block 322, following the MLP projection head 320 and/or block 324, following identification of the 2D teacher features 316.

In some aspects, a point cloud can be represented as follows:

$${℘}_{c} = \{ {p}_{i} , {f}_{i} \vert i = 1 , … , N \} .$$

In such a representation, N points are captured by one or more sensors (e.g., one or more LiDAR sensors or other type of sensor) at time t, where pᵢ∈ [symbol] ³ denotes the coordinate of the point and fᵢ∈ [symbol] ^{C} represents the corresponding feature. The systems and techniques described herein (e.g., system 300) can transfer knowledge from M surrounding camera images [symbol] ₜ={ [symbol] ᵢ|i=1, . . . , M}into the point cloud. Here, [symbol] ᵢ∈ [symbol] ^{H×W×3} denotes an image with height H and width W. Assuming that the point cloud [symbol] ₜ and images [symbol] ₜ are calibrated, the point cloud [symbol] ᵢ=(xᵢ, yᵢ, zᵢ) can be projected onto the image plane (uᵢ, vᵢ), such as using the following sensor calibration parameters:

$$[ \begin{matrix}{u}_{i} \\ {v}_{i} \\ 1\end{matrix} ] = \frac{1}{{z}_{i}} \times {Γ}_{k} \times {Γ}_{c ← l} \times [ \begin{matrix}{x}_{i} \\ {y}_{i} \\ {z}_{i}\end{matrix} ] ,$$

The variable Γₖ denotes the camera intrinsic matrix and Γ_{C←l} is the transformational matrix from the sensor(s) (e.g., LiDAR sensor(s)) to surrounding-view cameras. The 3D backbone (“student”) model (e.g., the 3D student model 310 of FIG. 3) may be represented as follows:

$${S}_{{θ}_{p}} : {ℝ}^{N \times ( 3 + K )} \to {ℝ}^{N \times D}$$

where S_{θ}_{ₚ} is a 3D backbone (“student”) with trainable parameters θ_{P}, which receives the points from the sensor(s) (e.g., LiDAR points) as input and outputs D-dimensional point features.

The image backbone (“teacher”) model (e.g., the 2D teacher model 312 of FIG. 3) may be represented as follows:

$${T}_{{θ}_{i}} : {ℝ}^{H \times W \times 3} \to {ℝ}^{\frac{N}{S} \times \frac{W}{S} \times E} ,$$

where the image backbone T_{θ}_{ᵢ} has pretrained parameters Oz that receives images as input and outputs E-dimensional image features, and where S refers to the downsampling factor by which the image backbone reduces the spatial feature dimension.

An objective of image-to-sensor (e.g., LiDAR sensor) representation learning is to transfer knowledge from the trained image backbone T_{θ}_{ᵢ} to the 3D backbone S_{θ}_{ₚ}. The objective function for the self-supervised knowledge distillation can be expressed as:

$${ℒ}_{distillation} = {ℒ}_{CM} + {L}_{occ} ,$$

where: [symbol] _{CM} is the original cross modal loss function and [symbol] _{occ} refers to occupancy prediction task.

To distill knowledge from visual foundation model or image backbone (e.g., the 2D teacher model 312 of FIG. 3) to 3D backbone model (e.g., the 3D student model 310 of FIG. 3), the systems and techniques described herein (e.g., system 300) can employ a cosine similarity loss. Cosine similarity loss provides a straightforward and stable optimization process, unlike previous approaches which rely on contrastive losses. Contrastive losses can require careful selection of negative samples and can suffer from sensitivity to batch composition. By contrast, cosine similarity loss allows for direct feature alignment without the need for negative pairs, making it both computationally efficient and robust.

Image features can be extracted using a vision transformer with weights from a particular model (e.g., a DINOv2 model). For LiDAR sensors, for example, disclosed solutions may use point-based networks, for example MinkUNet-34 and PointTransformer V3, which can be used as backbones directly in segmentation and with addition of point base detection head in 3D object detections tasks.

In some cases, the systems and techniques can use feature projection. While LiDAR features can be mapped into the image feature space using a simple linear layer, in some aspects, the systems and techniques can employ a multi-layer perceptron (MLP) (e.g., MLP projection head 320 of FIG. 3) for this transformation. Using the MLP can improve the quality of learned features and enhances cross-modal alignment. The MLP introduces non-linearity and greater expressiveness, allowing the 3D backbone model (e.g., the 3D student model 310 of FIG. 3) to better adapt to the distribution of image features, ultimately leading to improved performance across downstream tasks.

As noted previously, given the extracted features from both modalities (e.g., image and LiDAR or other sensors), the systems and techniques can compute the distillation as cosine similarity loss. For example, both feature sets can be normalized using L2 normalization to ensure scale consistency:

$${F}_{lidar} = \frac{{F}_{lidar}}{{‖ {F}_{lidar} ‖}_{2}} , {F}_{image} = \frac{{F}_{i m a g e}}{{‖ {F}_{i m a g e} ‖}_{2}} ,$$

where F_{lidar} are features after the MLP projection head and F_{image} are the concatenated feature matrices across a batch of input data (e.g., a batch of training data).

In some aspects, the final loss can be computed as the mean squared Euclidean distance between the normalized 3D (e.g., LiDAR, used in the equation as an illustrative example) and image feature vectors:

$${ℒ}_{distillation} = \frac{1}{N} {Σ}_{i = 1}^{N} {‖ {F}_{lidar , i}^{T} - {F}_{image , i} ‖}_{2}^{2} ,$$

where N is the total number of paired features across the batch.

By maximizing cosine similarity, the systems and techniques described herein can enforce consistent representations across modalities, enabling effective knowledge transfer without explicit semantic supervision.

Such cross-modal distillation offers several advantages. For example, cosine similarity loss simplifies optimization by eliminating the need for negative sample, usually coming from semantic pseudo-labels or superpixels reducing computational overhead and improving training stability. Further, replacing the traditional linear projection layer with an MLP significantly enhances feature alignment, improving feature representation and better performance on downstream tasks. Such a combination of simple yet effective design choices can result in a more robust and efficient cross-modal distillation framework.

Having an auxiliary spatial task (e.g., occupancy, scene flow, etc.) can be important, as it provides additional spatial context and regularization. The auxiliary spatial task can help the model learn more robust and generalizable 3D features. This can be particularly beneficial in the camera to 3D point (e.g., LiDAR) distillation process, where integrating a task that utilizes a 3D backbone to gain the spatial knowledge can significantly enhance the model's ability to understand and interpret complex 3D environments as well as making it more robust towards domain shifts and 3D point (e.g., LiDAR) corruption. In some cases, the occupancy prediction method involves, for each 3D point p sampled on the surface, two query points:

$${q}_{front} = p - δ p$$

$${q}_{behind} = p + δ p$$

where δp is a small distance, and q_{front} is considered empty, while q_{behind} is considered full.

Additionally, a third empty query point q_{sight} can be randomly picked in the segment between the sensor and p. These query points and their associated occupancies are used as the supervision signal to pre-train the backbone.

To estimate occupancy of neighboring points in a ball, the point features should learn about the surface orientation around the point, enabling the learning of better 3D reasoning. For each support point s, considering a neighborhood ball of radius r, the system and techniques can create inputs to the occupancy decoder by concatenating the latent vector zₛ and the local coordinates of the query with respect to the support. The occupancy decoder, which can include an MLP and a final sigmoid activation function, can predict the occupancy at q given the latent vector at s. The reconstruction loss [symbol] _{occup} can be a binary cross-entropy between the estimated occupancies and the actual sensor-based self-supervised occupancies, encouraging the latent vector zₛ to accurately reconstruct everything inside the ball centered at s. In some aspects, the objective can be described as:

$${L}_{occup} = \frac{1}{\vert S \vert} {Σ}_{s ϵ S} \frac{1}{\vert {Q}_{s} \vert} {Σ}_{q ϵ {Q}_{s}} [ {o}_{q} log ( {ô}_{q} \vert s ) + ( q - {O}_{q} ) log ( {ô}_{q} \vert s ) ] ,$$

where |S| represents the number of support points, and |Qₛ| denotes the number of query points within the ball centered on s.

FIG. 4 is a block diagram illustrating an example of inference for an improved machine learning system 400, in accordance with some aspects of the disclosure. As shown, system 400 receives point cloud data 401 (e.g., LIDAR point cloud data) and provides the point cloud data 401 to 3D student model 410, which can generate 3D student features 414 from the point cloud data 401. The 3D student model 410 may be trained using a system such as system 300 depicted with respect to FIG. 3, or by other techniques.

At inference, the 3D student features 414 generated by the trained 3D student model 410 can be used to perform multiple tasks, such as 3D and 2D object detection or semantic segmentation. For instance, the 3D student features 414 can be processed by a 3D semantic segmentation head 440 and a 3D object detection head 442. The 3D semantic segmentation head 440 can generate and output 3D points 450 with class labels. The 3D object detection head 442 can generate a detection output including 3D bounding boxes 452.

In some cases, during inference, the 3D student features 414 can also be processed by the trained MLP projection head 420. For example, MLP projection head 420 can project the 3D student features 414 to 2D features. The 2D features can be processed by model 444 to generate 2D bounding boxes 454 and by 2D semantic segmentation head 446 to generate 2D segmentation map 456. The resulting 3D features 414 can thus be used for tasks such as 3D segmentation or 3D object detection. The resulting 2D features output by the MLP projection head 420 are similarly semantically rich as the 2D foundational model features that were used during distillation and can be used to create 2D detection and segmentation outputs.

Various types of machine learning models can be used for 2D and 3D machine learning models described herein, such as the 3D student model 310, the 2D teacher model 312, and the 3D student model 410.

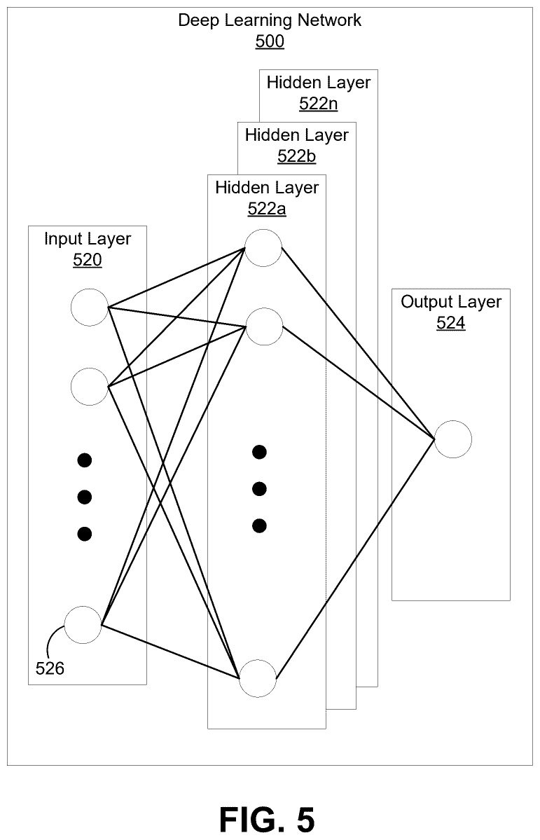

FIG. 5 is an illustrative example of a deep learning neural network 500 that can be used by one or more of the machine learning models. An input layer 520 includes input data. In some examples, the input layer 520 can include data representing the pixels of an input video frame. The neural network 500 includes multiple hidden layers 522a, 522b, through 522n. The hidden layers 522a, 522b, through 522n include n number of hidden layers, where n is an integer greater than or equal to one. The number of hidden layers can be made to include as many layers as needed for the given application.

The neural network 500 further includes an output layer 524 that provides an output resulting from the processing performed by the hidden layers 522a, 522b, through 522n. In some examples, the output layer 524 can provide a classification for an object in an input video frame. The classification can include a class identifying the type of object (e.g., a person, a dog, a cat, or other object).

The neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the hidden layers 522a, 522b, through 522n can transform the information of each input node by applying activation functions to the information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 524, at which an output is provided. In some cases, while nodes (e.g., node 526) in the neural network 500 are shown as having multiple output lines, a node has a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 524. In an example in which the neural network 500 is used to identify objects in images, the neural network 500 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 500 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 500 is trained well enough so that the weights of the layers are accurately tuned.

For the example of identifying objects in images, the forward pass can include passing a training image through the neural network 500. The weights are initially randomized before the neural network 500 is trained. The image can include, for example, an array of numbers representing the pixels of the image. Each number in the array can include a value from 0 to 255 describing the pixel intensity at that position in the array. In some examples, the array can include a 28×28×5 array of numbers with 28 rows and 28 columns of pixels and 5 color components (such as red, green, and blue, or luma and two chroma components, or the like).

For a first training iteration for the neural network 500, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 500 is unable to determine low level features and thus cannot make an accurate determination of what the classification of the object might be. A loss function can be used to analyze error in the output. Any suitable loss function definition can be used. An example of a loss function includes a mean squared error (MSE).

In an example, the MSE is defined as

$${E}_{total} = Σ \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values can be much different than the predicted output. The goal of training is to minimize the amount of loss so that the predicted output is the same as the training label. The neural network 500 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 500 can include any suitable deep network. As described previously, an example of a neural network 500 includes a convolutional neural network (CNN), which includes an input layer and an output layer, with multiple hidden layers between the input and out layers. An example of a CNN is described below with respect to FIG. 4. The hidden layers of a CNN include a series of convolutional, nonlinear, pooling (for downsampling), and fully connected layers. The neural network 500 can include any other deep network other than a CNN, such as an autoencoder, a deep belief nets (DBNs), a Recurrent Neural Networks (RNNs), among others.

FIG. 6 is an illustrative example of a convolutional neural network 600 (CNN 600). The input layer 620 of the CNN 600 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 622a, an optional non-linear activation layer, a pooling hidden layer 622b, and fully connected hidden layers 622c to get an output at the output layer 624. While only one of each hidden layer is shown in FIG. 6, one of ordinary skill will appreciate that multiple convolutional hidden layers, non-linear layers, pooling hidden layers, and/or fully connected layers can be included in the CNN 600. As previously described, the output can indicate a single class of an object or can include a probability of classes that best describe the object in the image.

The first layer of the CNN 600 is the convolutional hidden layer 622a. The convolutional hidden layer 622a analyzes the image data of the input layer 620. Each node of the convolutional hidden layer 622a is connected to a region of nodes (pixels) of the input image called a receptive field. The convolutional hidden layer 622a can be considered as one or more filters (each filter corresponding to a different activation or feature map), with each convolutional iteration of a filter being a node or neuron of the convolutional hidden layer 622a. For example, the region of the input image that a filter covers at each convolutional iteration would be the receptive field for the filter. In some examples, if the input image includes a 28×28 array, and each filter (and corresponding receptive field) is a 5×5 array, then there will be 26×26 nodes in the convolutional hidden layer 622a. Each connection between a node and a receptive field for that node learns a weight and, in some cases, an overall bias such that each node learns to analyze its particular local receptive field in the input image. Each node of the hidden layer 622a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 622a is due to each node of the convolutional layer being applied to its corresponding receptive field. For example, a filter of the convolutional hidden layer 622a can begin in the top-left corner of the input image array and can convolve around the input image. As noted above, each convolutional iteration of the filter can be considered a node or neuron of the convolutional hidden layer 622a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 622a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 622a.

The mapping from the input layer to the convolutional hidden layer 622a is referred to as an activation map (or feature map). The activation map includes a value for each node representing the filter results at each locations of the input volume. The activation map can include an array that includes the various total sum values resulting from each iteration of the filter on the input volume. For example, the activation map will include a 26×26 array if a 5×5 filter is applied to each pixel (a step amount of 1) of a 28×28 input image. The convolutional hidden layer 622a can include several activation maps in order to identify multiple features in an image. The example shown in FIG. 6 includes three activation maps. Using three activation maps, the convolutional hidden layer 622a can detect three different kinds of features, with each feature being detectable across the entire image.

In some examples, a non-linear hidden layer can be applied after the convolutional hidden layer 622a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 600 without affecting the receptive fields of the convolutional hidden layer 622a.

The pooling hidden layer 622b can be applied after the convolutional hidden layer 622a (and after the non-linear hidden layer when used). The pooling hidden layer 622b is used to simplify the information in the output from the convolutional hidden layer 622a. For example, the pooling hidden layer 622b can take each activation map output from the convolutional hidden layer 622a and generates a condensed activation map (or feature map) using a pooling function. Max-pooling is an example of a function performed by a pooling hidden layer. Other forms of pooling functions be used by the pooling hidden layer 622a, such as average pooling, L2-norm pooling, or other suitable pooling functions. A pooling function (e.g., a max-pooling filter, an L2-norm filter, or other suitable pooling filter) is applied to each activation map included in the convolutional hidden layer 622a. In the example shown in FIG. 6, three pooling filters are used for the three activation maps in the convolutional hidden layer 622a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 622a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 622a having a dimension of 26×26 nodes, the output from the pooling hidden layer 622b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 600.

The final layer of connections in the network is a fully-connected layer that connects every node from the pooling hidden layer 622b to every one of the output nodes in the output layer 624. Using the example above, the input layer includes 28×28 nodes encoding the pixel intensities of the input image, the convolutional hidden layer 622a includes 3×26×26 hidden feature nodes based on application of a 5×5 local receptive field (for the filters) to three activation maps, and the pooling layer 622b includes a layer of 3×12×12 hidden feature nodes based on application of max-pooling filter to 2×2 regions across each of the three feature maps. Extending this example, the output layer 624 can include ten output nodes. In such an example, every node of the 3×12×12 pooling hidden layer 622b is connected to every node of the output layer 624.

The fully connected layer 622c can obtain the output of the previous pooling layer 622b (which should represent the activation maps of high-level features) and determines the features that most correlate to a particular class. For example, the fully connected layer 622c layer can determine the high-level features that most strongly correlate to a particular class, and can include weights (nodes) for the high-level features. A product can be computed between the weights of the fully connected layer 622c and the pooling hidden layer 622b to obtain probabilities for the different classes. For example, if the CNN 600 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

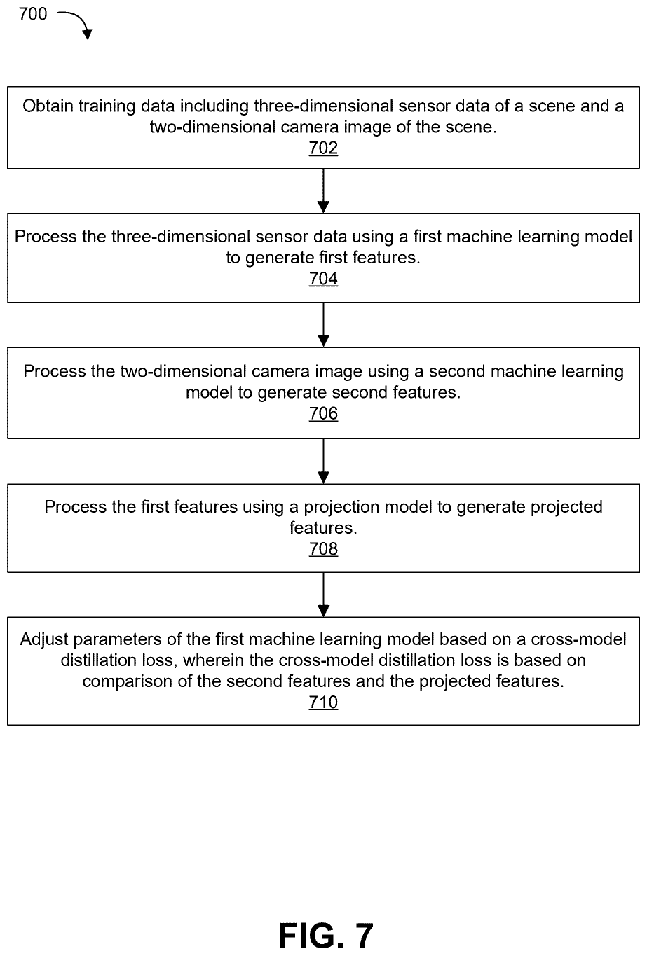

FIG. 7 is a flow diagram illustrating an example of a process for training a machine learning model, in accordance with some aspects of the disclosure.

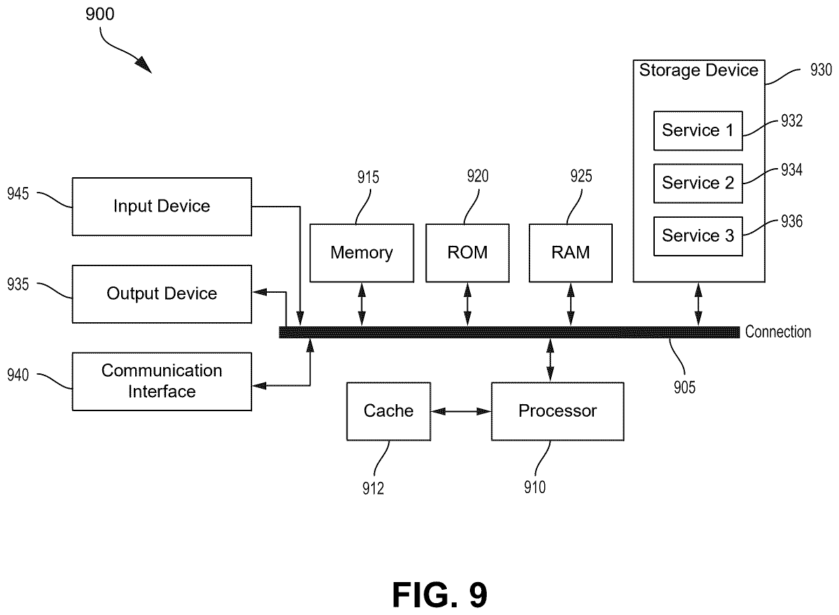

The processes 700 and 800 can be performed by a computing device (e.g., a computing device or computing system 900 of FIG. 9) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the processes 700 and 800 may be implemented as software components that are executed and run on one or more processors (e.g., processor 910 of FIG. 9, or other processor(s)). Further, the transmission and reception of signals by the computing device in the processes 700 and 800 may be enabled, for example, by one or more antennas and/or one or more transceivers (e.g., wireless transceiver(s)).

At block 702, the computing device (or component thereof) can obtain (e.g., access, receive) training data including three-dimensional sensor data of a scene and a two-dimensional camera image of the scene.

At block 704, the computing device (or component thereof) can process the three-dimensional sensor data using a first machine learning model to generate first features. In an aspect, the computing device (or component thereof) can provide the sensor data to a first machine learning model to obtain the first features.

At block 706, the computing device (or component thereof) can process the two-dimensional camera image using a second machine learning model to generate second features. In an aspect, the computing device (or component thereof) can provide the camera image to a second machine learning model to obtain second features.

At block 708, the computing device (or component thereof) can process the first features using a projection model to generate projected features.

In an aspect, the computing device (or component thereof) can correlate the sensor data and the camera image to determine correspondence data.

In an aspect, the computing device (or component thereof) can provide the first features and the correspondence data to a multi-layer perceptron head to obtain projected features.

In an aspect, the computing device can train the first machine learning model with a cross-model distillation loss and an occupancy self-supervised loss. The cross-model distillation loss is derived from the second features and the projected features.

At block 710, the computing device (or component thereof) can adjust parameters of the first machine learning model based on a cross-model distillation loss. The cross-model distillation loss may be based on comparison of the second features and the projected features.

In an aspect, the computing device (or component thereof) is further configured to correlate the three-dimensional sensor data and the two-dimensional camera image to determine correspondence data. In an aspect, the computing device (or component thereof) is further configured to process the correspondence data using the projection model to generate the projected features. In an aspect, the projection model is a multi-layer perceptron neural network model. In an aspect, the computing device (or component thereof) is configured to adjust the parameters of the first machine learning model further based on an occupancy self-supervised loss.

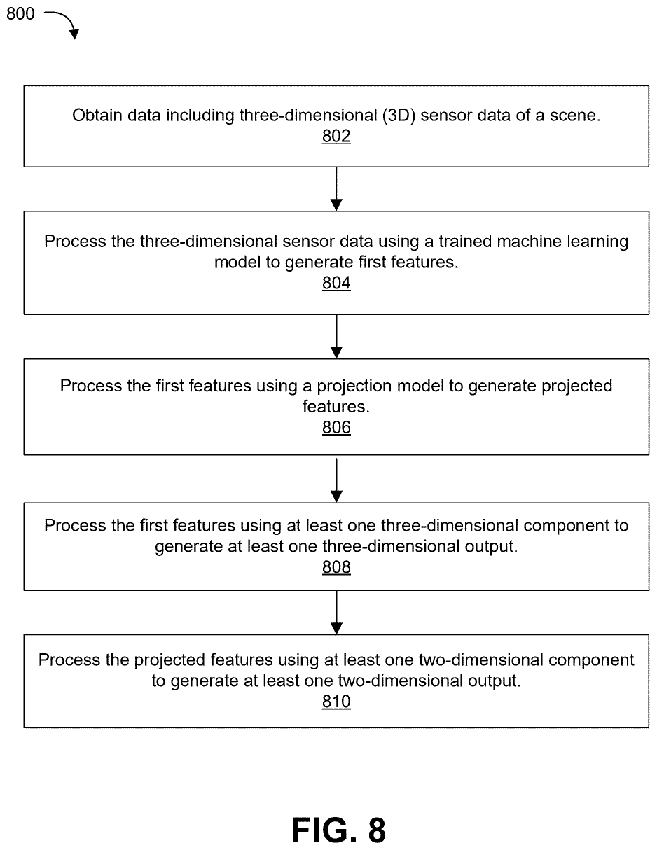

FIG. 8 is a flow diagram illustrating an example of a process for using a machine learning model, in accordance with some aspects of the disclosure.

At block 802, the computing device (or component thereof) can obtain data comprising three-dimensional (3D) sensor data of a scene. In some cases, the computing device can include the one or more sensors or can receive the sensor data from the one or more sensors. In some aspects, at least one sensor of the one or more sensors is an image sensor, a radar sensor, a light detection and ranging (LIDAR) sensor, and/or other type of sensor.

In some cases, the sensor data includes a plurality of images (e.g., captured by an image sensor such as a camera). In some aspects, the sensor data includes radar data (e.g., captured by a radar sensor) and/or LIDAR data (e.g., captured by a LIDAR sensor).

At block 804, the computing device (or component thereof) can process the three-dimensional sensor data using a trained machine learning model to generate first features. In an aspect, the computing device can provide the sensor data to a trained machine learning model to obtain first features.

At block 806, the computing device (or component thereof) can process the first features using a projection model to generate projected features. In an aspect, the computing device can provide the first features to a multilayer perceptron (MLP) projection head to obtain projected features.

At block 808, the computing device (or component thereof) can process the first features using at least one three-dimensional component to generate at least one three-dimensional output. In an aspect, the computing device can provide the first features to one or more three-dimensional components to obtain the three-dimensional features.

At block 810, the computing device (or component thereof) can process the projected features using at least one two-dimensional component to generate at least one two-dimensional output. In an aspect, the computing device can provide the projected features to one or more two-dimensional components to obtain two-dimensional features.

In an aspect, the projection model is a multi-layer perceptron neural network model. In an aspect, the at least one three-dimensional component includes a 3D semantic segmentation head and the at least one three-dimensional output includes three-dimensional points including class labels. In an aspect, the at least one three-dimensional component includes a 3D object detection head and the at least one three-dimensional output includes three-dimensional bounding boxes. In an aspect, the computing device (or component thereof) is further configured to provide the three-dimensional sensor data of the scene to the projection model. The projection model may be configured to output the projected features at least in part based on the three-dimensional sensor data. In an aspect, the at least one two-dimensional component includes a two-dimensional object detection head and the at least one two-dimensional output includes at least one two-dimensional bounding box. In an aspect, the at least one two-dimensional component includes a two-dimensional semantic segmentation head and the at least one two-dimensional output includes a two-dimensional segmentation map. In an aspect, the three-dimensional sensor data is received from a light detection and ranging (LIDAR) sensor.

In some cases, the computing device of process 800 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 800 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

In some aspects, training of one or more of the machine learning systems or neural networks described herein (e.g., any of the machine learning models/systems or neural networks described with respect to FIG. 3-FIG. 6, among various other machine learning models, systems, or networks described herein) can be performed using online training (e.g., in some case on-device training), offline training, and/or various combinations of online and offline training. In some cases, online may refer to time periods during which the input data (e.g., such as the point cloud and/or camera images input described with respect to FIG. 3 and FIG. 4, etc.) is processed, for instance for performance of the distillation techniques implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 9 is a block diagram illustrating an example of a computing system 900, which may be employed for a scene classification based object (e.g., traffic sign) collection trigger. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LIDAR sensors, laser range finders, RF radars, ultrasonic sensors, and infrared (IR) sensors) configured to collect data and provide measurements to processor 910, whereby processor 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include one or more memories, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for training a machine learning model, the apparatus comprising: one or more memories; and at least one processor coupled to the one or more memories and configured to: obtain training data comprising three-dimensional sensor data of a scene and a two-dimensional camera image of the scene; process the three-dimensional sensor data using a first machine learning model to generate first features; process the two-dimensional camera image using a second machine learning model to generate second features; process the first features using a projection model to generate projected features; and adjust parameters of the first machine learning model based on a cross-model distillation loss, wherein the cross-model distillation loss is based on comparison of the second features and the projected features.

Aspect 2. The apparatus of Aspect 1, wherein the at least one processor is configured to: correlate the three-dimensional sensor data and the two-dimensional camera image to determine correspondence data; and process the correspondence data using the projection model to generate the projected features.

Aspect 3. The apparatus of any of Aspects 1 or 2, wherein the projection model is a multi-layer perceptron neural network model.

Aspect 4. The apparatus of any of Aspects 1 to 3, wherein the at least one processor is configured to adjust the parameters of the first machine learning model further based on an occupancy self-supervised loss.

Aspect 5. The method of any of Aspects 1 to 4, further comprising obtaining data comprising additional three-dimensional sensor data of an additional scene; processing the additional three-dimensional sensor data using the first machine learning model to generate first features; processing the first features using the projection model to generate projected features; processing the first features using at least one three-dimensional component to generate at least one three-dimensional output; and processing the projected features using at least one two-dimensional component to generate at least one two-dimensional output.

Aspect 6. The method of Aspect 5, wherein the at least one three-dimensional component comprises a 3D semantic segmentation head and the at least one three-dimensional output includes three-dimensional points comprising class labels, and wherein the at least one three-dimensional component comprises a 3D object detection head and the at least one three-dimensional output includes three-dimensional bounding boxes.

Aspect 7. The method of any of Aspects 5 or 6, further comprising providing the three-dimensional sensor data of the scene to the projection model, and wherein the projection model is configured to output the projected features at least in part based on the three-dimensional sensor data.

Aspect 8. The method of any of Aspects 5 to 7, wherein the at least one two-dimensional component comprises a two-dimensional object detection head and the at least one two-dimensional output includes at least one two-dimensional bounding box.

Aspect 9. An apparatus using a machine learning model, the apparatus comprising: one or more memories; and one or more processors coupled to the one or more memories and configured to: obtain data comprising three-dimensional sensor data of a scene; process the three-dimensional sensor data using a trained machine learning model to generate first features; process the first features using a projection model to generate projected features; process the first features using at least one three-dimensional component to generate at least one three-dimensional output; and process the projected features using at least one two-dimensional component to generate at least one two-dimensional output.

Aspect 10. The apparatus of Aspect 9, wherein the projection model is a multi-layer perceptron neural network model.

Aspect 11. The apparatus of any of Aspects 9 or 10, wherein the at least one three-dimensional component comprises a 3D semantic segmentation head and the at least one three-dimensional output includes three-dimensional points comprising class labels.

Aspect 12. The apparatus of any of Aspects 9 to 11, wherein the at least one three-dimensional component comprises a 3D object detection head and the at least one three-dimensional output includes three-dimensional bounding boxes.

Aspect 13. The apparatus of any of Aspects 9 to 12, wherein the one or more processors are configured to provide the three-dimensional sensor data of the scene to the projection model, and wherein the projection model is configured to output the projected features at least in part based on the three-dimensional sensor data.

Aspect 14. The apparatus of any of Aspects 9 to 13, wherein the at least one two-dimensional component comprises a two-dimensional object detection head and the at least one two-dimensional output includes at least one two-dimensional bounding box.

Aspect 15. The apparatus of any of Aspects 9 to 14, wherein the at least one two-dimensional component comprises a two-dimensional semantic segmentation head and the at least one two-dimensional output includes a two-dimensional segmentation map.

Aspect 16. The apparatus of any of Aspects 9 to 15, wherein the three-dimensional sensor data is received from a light detection and ranging (LIDAR) sensor.

Aspect 17. The apparatus of any of Aspects 9 to 16, further comprising the LIDAR sensor.

Aspect 18. A method for training a machine learning model, the method comprising: obtaining training data comprising three-dimensional sensor data of a scene and a two-dimensional camera image of the scene; processing the three-dimensional sensor data using a first machine learning model to generate first features; processing the two-dimensional camera image using a second machine learning model to generate second features; processing the first features using a projection model to generate projected features; and adjusting parameters of the first machine learning model based on a cross-model distillation loss, wherein the cross-model distillation loss is based on comparison of the second features and the projected features.

Aspect 19. The method of Aspect 18, further comprising: correlating the three-dimensional sensor data and the two-dimensional camera image to determine correspondence data; and processing the correspondence data using the projection model to generate the projected features.

Aspect 20. The method of any of Aspects 18 or 19, wherein the projection model is a multi-layer perceptron neural network model.

Aspect 21. The method any of Aspects 18 to 20, further comprising adjusting the parameters of the first machine learning model further based on an occupancy self-supervised loss.

Aspect 22. The method of any of Aspects 18 to 21, further comprising obtaining data comprising additional three-dimensional sensor data of an additional scene; processing the additional three-dimensional sensor data using the first machine learning model to generate first features; processing the first features using the projection model to generate projected features; processing the first features using at least one three-dimensional component to generate at least one three-dimensional output; and processing the projected features using at least one two-dimensional component to generate at least one two-dimensional output.

Aspect 23. The method of Aspect 22, wherein the at least one three-dimensional component comprises a 3D semantic segmentation head and the at least one three-dimensional output includes three-dimensional points comprising class labels, and wherein the at least one three-dimensional component comprises a 3D object detection head and the at least one three-dimensional output includes three-dimensional bounding boxes.

Aspect 24. The method of any of Aspects 22 to 23, further comprising providing the three-dimensional sensor data of the scene to the projection model, and wherein the projection model is configured to output the projected features at least in part based on the three-dimensional sensor data.

Aspect 25. The method of any of Aspects 22 to 24, wherein the at least one two-dimensional component comprises a two-dimensional object detection head and the at least one two-dimensional output includes at least one two-dimensional bounding box.

Aspect 26. A method of using a machine learning model, the method comprising: obtaining data comprising three-dimensional sensor data of a scene; processing the three-dimensional sensor data using a trained machine learning model to generate first features; processing the first features using a projection model to generate projected features; processing the first features using at least one three-dimensional component to generate at least one three-dimensional output; and processing the projected features using at least one two-dimensional component to generate at least one two-dimensional output.

Aspect 27. The method of Aspect 26, wherein the projection model is a multi-layer perceptron neural network model.

Aspect 28. The method of any of Aspects 26 or 27, wherein the at least one three-dimensional component comprises a 3D semantic segmentation head and the at least one three-dimensional output includes three-dimensional points comprising class labels.

Aspect 29. The method of any of Aspects 26 to 28, wherein the at least one three-dimensional component comprises a 3D object detection head and the at least one three-dimensional output includes three-dimensional bounding boxes.

Aspect 30. The method of any of Aspects 26 to 29, further comprising providing the three-dimensional sensor data of the scene to the projection model, and wherein the projection model is configured to output the projected features at least in part based on the three-dimensional sensor data.

Aspect 31. The method of any of Aspects 26 to 30, wherein the at least one two-dimensional component comprises a two-dimensional object detection head and the at least one two-dimensional output includes at least one two-dimensional bounding box.

Aspect 32. The method of any of Aspects 26 to 31, wherein the at least one two-dimensional component comprises a two-dimensional semantic segmentation head and the at least one two-dimensional output includes a two-dimensional segmentation map.

Aspect 33. The method of any of Aspects 26 to 32, wherein the three-dimensional sensor data is received from a light detection and ranging (LIDAR) sensor.

Aspect 34. A non-transitory computer-readable medium having stored thereon instructions that, when executed by at least one processor, cause the at least one processor to perform operations according to any of Aspects 18 to 25.

Aspect 35. An apparatus for training a machine learning model, the apparatus including one or more means for performing operations according to any of Aspects 18 to 25.

Aspect 36. A non-transitory computer-readable medium having stored thereon instructions that, when executed by at least one processor, cause the at least one processor to perform operations according to any of Aspects 26 to 33.

Aspect 37. An apparatus for using a machine learning model (e.g., at inference), the apparatus including one or more means for performing operations according to any of Aspects 26 to 33.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus using a machine learning model, the apparatus comprising:
at one or more memories configured to store data comprising three-dimensional sensor data of a scene; and
one or more processors coupled to the one or more memories and configured to:
obtain the data;
process the three-dimensional sensor data using a trained machine learning model to generate first features;
process the first features using a projection model to generate projected features;
process the first features using at least one three-dimensional component to generate at least one three-dimensional output; and
process the projected features using at least one two-dimensional component to generate at least one two-dimensional output.

2. The apparatus of claim 1, wherein the projection model is a multi-layer perceptron neural network model.

3. The apparatus of claim 1, wherein the at least one three-dimensional component comprises a 3D semantic segmentation head and the at least one three-dimensional output includes three-dimensional points comprising class labels.

4. The apparatus of claim 1, wherein the at least one three-dimensional component comprises a 3D object detection head and the at least one three-dimensional output includes three-dimensional bounding boxes.

5. The apparatus of claim 1, wherein the one or more processors are configured to provide the three-dimensional sensor data of the scene to the projection model, and wherein the projection model is configured to output the projected features at least in part based on the three-dimensional sensor data.

6. The apparatus of claim 1, wherein the at least one two-dimensional component comprises a two-dimensional object detection head and the at least one two-dimensional output includes at least one two-dimensional bounding box.

7. The apparatus of claim 1, wherein the at least one two-dimensional component comprises a two-dimensional semantic segmentation head and the at least one two-dimensional output includes a two-dimensional segmentation map.

8. The apparatus of claim 1, wherein the three-dimensional sensor data is received from a light detection and ranging (LIDAR) sensor.

9. The apparatus of claim 8, further comprising the LIDAR sensor.

10. A method using a machine learning model, method comprising:
obtaining data comprising three-dimensional sensor data of a scene;
processing the three-dimensional sensor data using a trained machine learning model to generate first features;
processing the first features using a projection model to generate projected features;
processing the first features using at least one three-dimensional component to generate at least one three-dimensional output; and
processing the projected features using at least one two-dimensional component to generate at least one two-dimensional output.

11. The method of claim 10, wherein the at least one three-dimensional component comprises a 3D semantic segmentation head and the at least one three-dimensional output includes three-dimensional points comprising class labels, and wherein the at least one three-dimensional component comprises a 3D object detection head and the at least one three-dimensional output includes three-dimensional bounding boxes.

12. The method of claim 10, further comprising providing the three-dimensional sensor data of the scene to the projection model, and wherein the projection model is configured to output the projected features at least in part based on the three-dimensional sensor data.

13. The method of claim 10, wherein the at least one two-dimensional component comprises a two-dimensional object detection head and the at least one two-dimensional output includes at least one two-dimensional bounding box.

14. An apparatus for training a machine learning model, the apparatus comprising:
at one or more memories configured to store training data; and
one or more processors coupled to the one or more memories and configured to:
obtain the training data comprising three-dimensional sensor data of a scene and a two-dimensional camera image of the scene;
process the three-dimensional sensor data using a first machine learning model to generate first features;
process the two-dimensional camera image using a second machine learning model to generate second features;
process the first features using a projection model to generate projected features; and
adjust parameters of the first machine learning model based on a cross-model distillation loss, wherein the cross-model distillation loss is based on comparison of the second features and the projected features.

15. The apparatus of claim 14, wherein the one or more processors are configured to:
correlate the three-dimensional sensor data and the two-dimensional camera image to determine correspondence data; and
processing the correspondence data using the projection model to generate the projected features.

16. The apparatus of claim 14, wherein the projection model is a multi-layer perceptron neural network model.

17. The apparatus of claim 14, further comprising adjusting the parameters of the first machine learning model further based on an occupancy self-supervised loss.

18. The apparatus of claim 14, wherein the one or more processors are configured to:
obtain data comprising additional three-dimensional sensor data of an additional scene;
process the additional three-dimensional sensor data using the first machine learning model to generate first features;
process the first features using the projection model to generate projected features;
process the first features using at least one three-dimensional component to generate at least one three-dimensional output; and
process the projected features using at least one two-dimensional component to generate at least one two-dimensional output.

19. The apparatus of claim 18, wherein the at least one three-dimensional component comprises a 3D semantic segmentation head and the at least one three-dimensional output includes three-dimensional points comprising class labels, and wherein the at least one three-dimensional component comprises a 3D object detection head and the at least one three-dimensional output includes three-dimensional bounding boxes.

20. The apparatus of claim 17, further comprising providing the three-dimensional sensor data of the scene to the projection model, and wherein the projection model is configured to output the projected features at least in part based on the three-dimensional sensor data.
